(19) United States
(12) Patent Application Publication
(10) Pub. No.: US 2012/0194000 A1
(43) Pub. Date: Aug. 2, 2012

(54) POWER TRANSMITTING DEVICE AND POWER TRANSMITTING APPARATUS

(75) Inventor: Akiyoshi UCHIDA, Kawasaki (JP)

(73) Assignee: FUJITSU LIMITED, Kawasaki-shi (JP)

(21) Appl. No.: 13/444,581

(22) Filed: Apr. 11, 2012

Related U.S. Application Data
(63) Continuation of application No. PCT/JP2009/070026, filed on Nov. 27, 2009.

(51) Int. Cl. H01F 38/00

(52) U.S. Cl. 307/104

(57) ABSTRACT

A power transmitting device includes a power transmitting coil having a resonance point different from that of a power receiving resonant coil, which transmits power supplied from a power supply unit as magnetic field energy to the power receiving resonant coil which resonates at a resonant frequency causing magnetic field resonance. A power receiving device includes the power receiving resonant coil which receives the magnetic field energy transmitted from the power transmitting coil at the resonant frequency.

### CROSS-REFERENCE TO RELATED APPLICATION

This application is a continuing application, filed under 35 U.S.C. §111(a), of International Application PCT/JP2009/070026, filed on Nov. 27, 2009.

### FIELD

The embodiment discussed herein is related to a power transmitting device and power transmitting apparatus which wirelessly supply power.

### BACKGROUND

As a wireless power supply technique, a technique using electromagnetic induction and a technique using radio waves are generally known. On the other hand, in recent years, a technique using a magnetic field resonance has been proposed (see, for example, Japanese National Publication of International Patent Application No. 2009-501510).

In the wireless power supply technique using the magnetic field resonance, for example, a power transmitting resonant coil having a resonant frequency of fr1 is provided in a power transmitting device, and a power receiving resonant coil having a resonant frequency of fr2 is provided in a power receiving device. By synchronizing the resonant frequencies fr1 and fr2, and appropriately adjusting the size and arrangement of the above coils, a magnetic field coupling is generated in which energy may be transferred between the power transmitting device and the power receiving device by the magnetic field resonance. As a result, power is wirelessly transmitted from the power transmitting resonant coil of the power transmitting device to the power receiving resonant coil of the power receiving device. According to such a wireless power supply technique, power transmission efficiency (energy transfer efficiency) may be several tens of percent, so that a distance between the power transmitting device and the power receiving device may be relatively large, for example, several tens of centimeters or larger for a resonator having a size of several tens of centimeters.

However, there is a problem that in the wireless power supply using the magnetic field resonance, when a distance between the power transmitting resonant coil of the power transmitting device and the power receiving resonant coil of the power receiving device becomes short, transmitted power is reduced.

### SUMMARY

In one aspect of the embodiments, there is provided a power transmitting device including a power transmitting coil having a resonance point different from that of a power receiving resonant coil which transmits power supplied from a power supply unit as magnetic field energy to the power receiving resonant coil which resonates at a resonant frequency causing magnetic field resonance.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a power transmitting apparatus according to the present embodiment;

FIG. 2 illustrates a relationship between transmitted power and a distance between a power transmitting coil and a power receiving resonant coil;

FIG. 3 illustrates an application example of a power transmitting apparatus;

FIG. 4 illustrates another application example of a power transmitting apparatus;

FIG. 5 illustrates a magnetic field resonance system;

FIG. 6 illustrates an equivalent circuit of a power transmitting resonant coil and a power receiving resonant coil;

FIG. 7 illustrates a relationship between a transmission frequency and transmitted power in the case where a distance between a power transmitting resonant coil and a power receiving resonant coil is optimized;

FIG. 8 illustrates a relationship between a transmission frequency and transmitted power in the case where a distance between a power transmitting resonant coil and a power receiving resonant coil is shorter than an optimum distance; and

FIG. 9 illustrates a relationship between transmitted power and a distance between a power transmitting resonant coil and a power receiving resonant coil.

### DESCRIPTION OF EMBODIMENTS

In wireless power supply using magnetic field resonance, a relationship between transmitted power and a distance between a power transmitting resonant coil and a power receiving resonant coil will be first described. Hereinafter, a preferred embodiment of the present invention will now be described in detail below with reference to the accompanying drawings, wherein like reference numerals refer to like elements throughout.

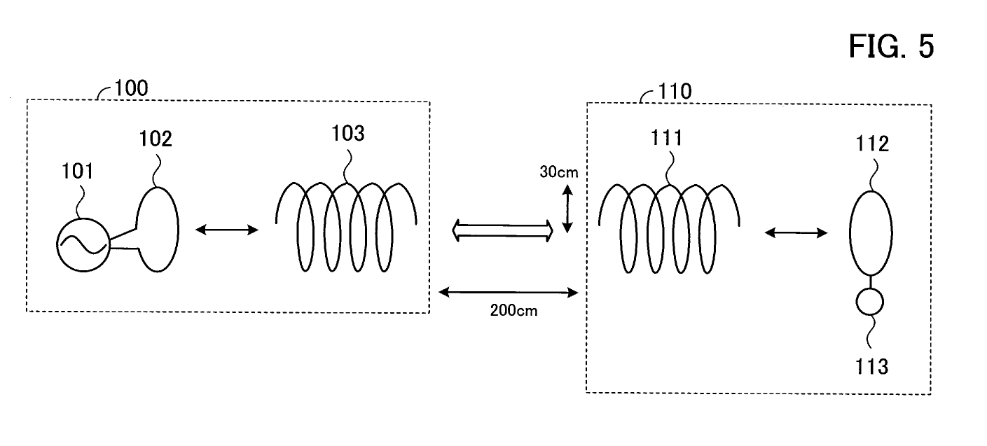

FIG. 5 illustrates a magnetic field resonance system. As illustrated in FIG. 5, the magnetic field resonance system includes a power transmitting device 100 having a power supply unit 101, a power supply coil 102, and a power transmitting resonant coil 103; and a power receiving device 110 having a power receiving resonant coil 111, a power pickup coil 112, and a load 113.

The power supply unit 101 supplies power to the power supply coil 102. The power supply unit 101 is, for example, a Colpitts oscillator circuit, and oscillates at a resonant frequency of the power transmitting resonant coil 103 and at a resonant frequency of the power receiving resonant coil 111.

To the power supply coil 102, the power supply unit 101 is connected. The power supply coil 102 supplies power supplied from the power supply unit 101 to the power transmitting resonant coil 103 through electromagnetic induction.

The power transmitting resonant coil 103 is, for example, a helical coil having inductance L, and both ends of which are released. The power transmitting resonant coil 103 has stray capacitance. As a result, the power transmitting resonant coil 103 serves as an LC oscillator circuit. In FIG. 5, stray capacitance is assumed, and further a capacitor element may be inserted into the power transmitting resonant coil 103.

In the same manner as in the power transmitting resonant coil 103, for example, the power receiving resonant coil 111 is also a helical coil having inductance L, and both ends of which are released. Also, in the same manner as in the power transmitting resonant coil 103, the power receiving resonant coil 111 has stray capacitance, or a capacitor element may be inserted thereinto. As a result, the power receiving resonant coil 111 serves as an LC oscillator circuit.

The resonant frequency of the power transmitting resonant coil 103 and the resonant frequency of the power receiving resonant coil 111 are set so as to be the same as each other. Through the process, power is transmitted as magnetic field energy by using magnetic field resonance from the power transmitting resonant coil 103 to the power receiving resonant coil 111.

The power receiving resonant coil 111 supplies power to a power pickup coil 112 through electromagnetic induction. To the power pickup coil 112, for example, a load 113 such as a battery is connected and the received power is charged into the battery.

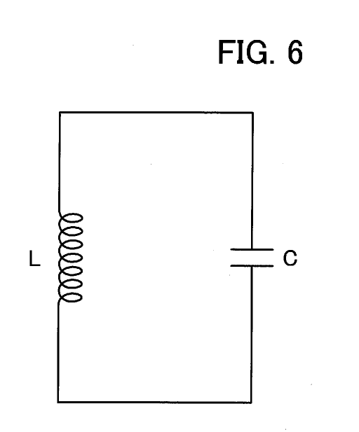

FIG. 6 illustrates an equivalent circuit of a power transmitting resonant coil and a power receiving resonant coil. As described above, the power transmitting resonant coil 103 and the power receiving resonant coil 111 each have inductance L and stray capacitance C. Alternatively, to the power transmitting resonant coil 103 and the power receiving resonant coil 111, a capacitor element may be connected, respectively. Accordingly, the equivalent circuits of the power transmitting resonant coil 103 and the power receiving resonant coil 111 serve as an LC oscillator circuit as illustrated in FIG. 6. A resonant frequency f is represented by the following formula (1).

f=1/{2π(LC)^{1/2}} (1)

Accordingly, in order to match the resonant frequency of the power transmitting resonant coil 103 with the resonant frequency of the power receiving resonant coil 111, the products of L and C of the respective coils are set so as to be the same as each other.

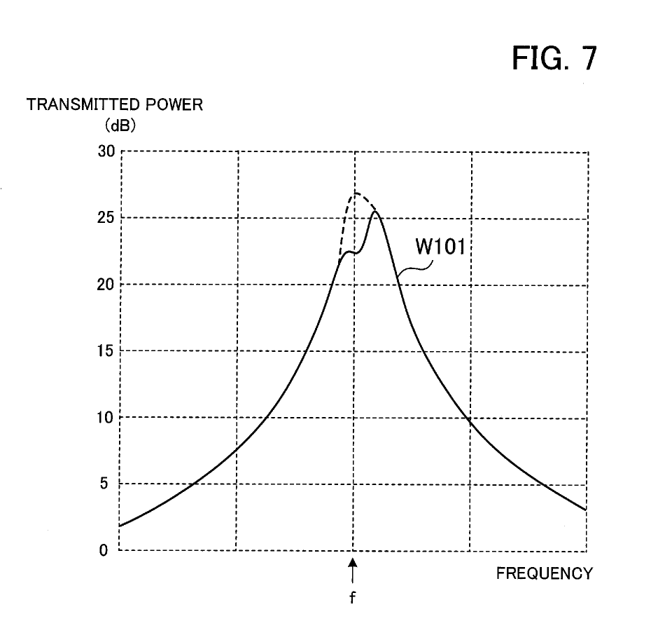

FIG. 7 illustrates a relationship between the transmission frequency and the transmitted power in the case where a distance between a power transmitting resonant coil and a power receiving resonant coil is optimal. In FIG. 7, the horizontal axis represents the frequency, and the vertical axis represents the transmitted power (dB). The transmission frequency is the resonant frequency of the power transmitting resonant coil 103 and the resonant frequency of the power receiving resonant coil 111.

In the case where a distance between the power transmitting resonant coil 103 and the power receiving resonant coil 111 is optimal, the transmitted power is illustrated by a waveform W101 of FIG. 7. In other words, the transmitted power changes in accordance with a change in the transmission frequency. When the transmission frequency is near the resonant frequency f, the transmitted power is maximized.

In FIG. 7, a shape around the apex of the waveform W101 is slightly distorted. This depends upon various conditions other than the resonant frequency of the power transmitting resonant coil 103 and the power receiving resonant coil 111. Therefore, in FIG. 7, the transmitted power is not maximized in the case where the transmission frequency is the resonant frequency f. However, in an ideal case, the transmitted power may be assumed to be maximized in the case where the transmission frequency is the resonant frequency f as indicated by a dotted line.

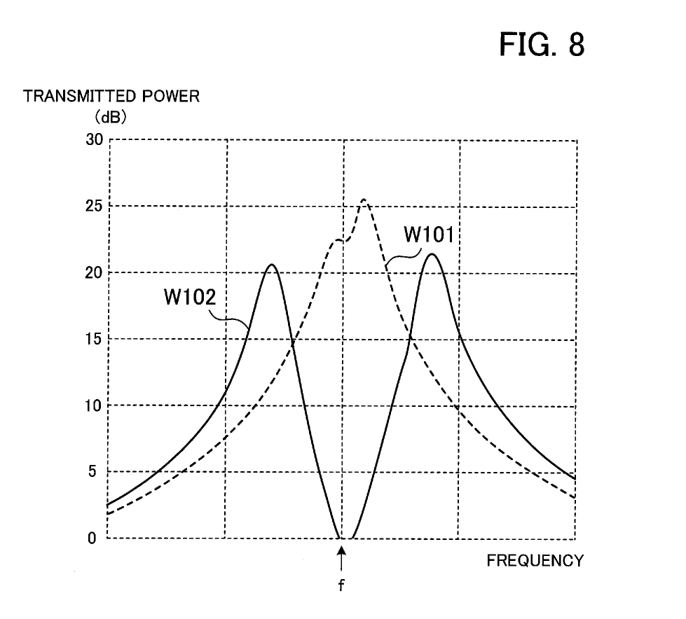

FIG. 8 illustrates a relationship between the transmission frequency and the transmitted power in the case where a distance between the power transmitting resonant coil and the power receiving resonant coil is shorter than an optimal distance. In FIG. 8, the horizontal axis represents the frequency, and the vertical axis represents the transmitted power (dB). In addition, the waveform W101 at the time of the optimal distance illustrated in FIG. 7 is illustrated in FIG. 8.

In the case where the distance between the power transmitting resonant coil 103 and the power receiving resonant coil 111 is shorter than the optimal distance, the transmitted power is illustrated by the waveform W102 of FIG. 8. In other words, the transmitted power illustrated by the waveform W102 of FIG. 8 has two peaks, and becomes a so-called split state. Accordingly, in the case where the distance between the power transmitting resonant coil 103 and the power receiving resonant coil 111 is shorter than the optimal distance, when the transmission frequency is the resonant frequency f, the transmitted power is reduced.

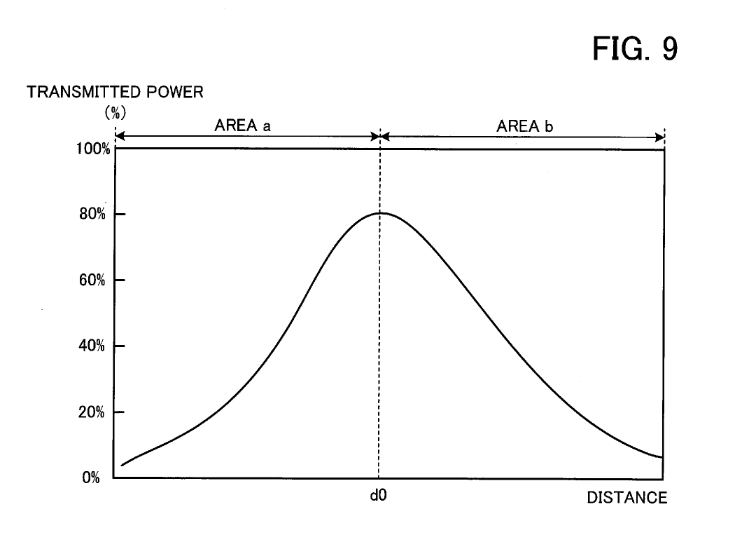

FIG. 9 illustrates a relationship between the transmitted power and the distance between the power transmitting resonant coil and the power receiving resonant coil. In FIG. 9, the horizontal axis represents the distance between the power transmitting resonant coil 103 and the power receiving resonant coil 111, and the vertical axis represents the normalized transmitted power (%). The transmission frequency is a constant value of the resonant frequency f, and the power supplied to the power transmitting resonant coil 103 is a constant value of 100%.

As illustrated in FIG. 9, the transmitted power changes in accordance with the change in a coil distance which is a distance between the power transmitting resonant coil 103 and the power receiving resonant coil 111. Specifically, the transmitted power is maximized in the case where the coil distance is the optimal distance d0. In other words, the coil distance at which the transmitted power is maximized is the optimal distance d0 between the power transmitting resonant coil 103 and the power receiving resonant coil 111 at the resonant frequency f.

In the case where the coil distance is shorter than the optimal distance d0, in other words, the coil distance is in the area “a” illustrated in FIG. 9, the transmitted power is more reduced as the coil distance becomes shorter than the optimal distance d0. This corresponds to the case of the waveform W102 illustrated in FIG. 8. On the other hands, in the case where the coil distance is longer than the optimal distance d0, in other words, the coil distance is in the area “b” illustrated in FIG. 9, the transmitted power is more reduced as the coil distance becomes longer than the optimal distance d0. This corresponds to the case of the waveform W101 illustrated in FIG. 7.

As described above, in the wireless power supply system using the magnetic field resonance, the transmitted power is reduced in the case where the coil distance between the power transmitting resonant coil 103 and the power receiving resonant coil 111 changes from the optimal distance d0. As illustrated in FIG. 9, for example, as the coil distance between the power transmitting resonant coil 103 and the power receiving resonant coil 111 is shorter, the transmitted power is more reduced.

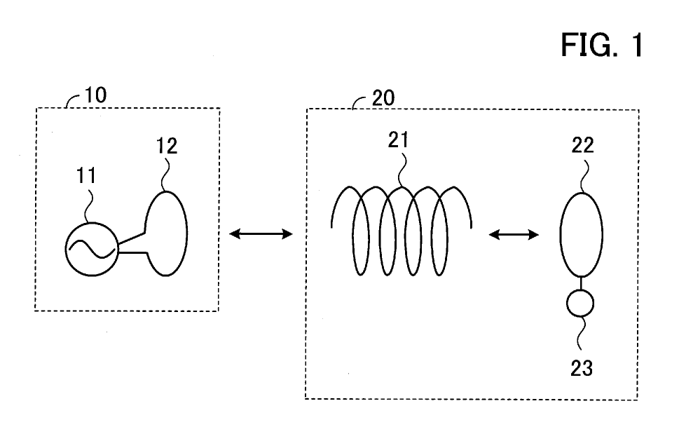

FIG. 1 illustrates the power transmitting apparatus according to the present embodiment. As illustrated in FIG. 1, the power transmitting apparatus includes a power transmitting device 10 having a power supply unit 11 and a power transmitting coil 12, and a power receiving device 20 having a power receiving resonant coil 21, a power pickup coil 22, and a load 23. Note that the power receiving resonant coil 21, power pickup coil 22, and load 23 of the power receiving device 20 are the same as the power receiving resonant coil 111, power pickup coil 112, and load 113 of the power receiving device 110 illustrated in FIG. 5, and the description will not be repeated here.

The power supply unit 11 supplies power to the power transmitting coil 12. The power supply unit 11 is, for example, a Colpitts oscillator circuit, and oscillates at a resonant frequency of the power receiving resonant coil 21.

To the power transmitting coil 12, the power supply unit 11 is connected. The power transmitting coil 12 supplies power supplied from the power supply unit 11 to the power receiving resonant coil 21 through magnetic field energy.

As illustrated in FIG. 5, the power receiving resonant coil 21 serves as an LC resonance circuit through stray capacitance or insertion of a capacitor element. Accordingly, suppose, for example, that the resonant frequency of the power receiving resonant coil 21 is set in the same manner as in the power transmitting resonant coil 103 of the power transmitting device 100 illustrated in FIG. 5. In this case, magnetic field resonance occurs and the power receiving resonant coil 21 receives power from the power transmitting device 100 at high transmission efficiency.

On the other hand, in an ideal case, the power transmitting coil 12 has only an inductance component and fails to serve as an LC resonance circuit. However, the power transmitting coil 12 actually has extremely small stray capacitance. In addition, the power transmitting coil 12 has capacitance through the connected power supply unit 11, and therefore serves as an LC oscillator circuit. Accordingly, the power transmitting coil 12 has the resonant frequency different from that of the power receiving resonant coil 21 which forms an LC oscillator circuit in which stray capacitance is aggressively used or into which a capacitor element is inserted. Through the process, the power transmitting coil 12 and the power receiving resonant coil 21 transmit and receive power without using the magnetic field resonance illustrated in FIG. 5.

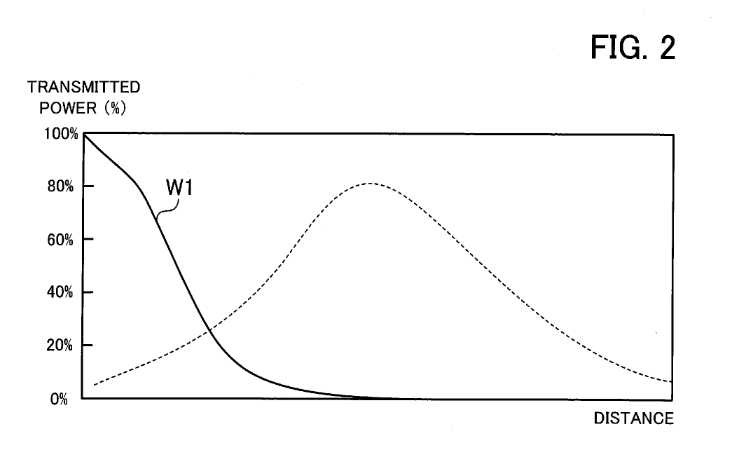

In the power transmitting apparatus of FIG. 1, one oscillator circuit is located within the optimal distance d0 (area “a” illustrated in FIG. 9) from the power transmitting coil 12 and resonates with magnetic field energy transmitted from the power transmitting coil 12. That oscillator circuit corresponds to only the power receiving resonant coil 21. When the oscillator circuit located in the area “a” is set only to the power receiving resonant coil 21, the transmitted power at the resonant frequency is prevented from being reduced as illustrated in FIG. 8. When the resonance circuit located in the area “a” is set as the power receiving resonant coil 21, the power transmitting apparatus of FIG. 1 is larger than the electromagnetic induction in the transmitted power. At the same time, the power transmitting apparatus of FIG. 1 is wider than the electromagnetic induction in a degree of freedom of positions and attitudes. More preferably, designing is performed so that one resonant circuit may be used in a range (hereinafter, referred to as an optimal range), being an area closer than the area “a”, within a distance in which a solid line and dotted line illustrated in FIG. 2 intersect each other. In other words, the optimal range is a range in which the transmitted power more increases in a state of one resonant coil as compared with that of two resonant coils. The number of the resonant coils herein is equal to the number of the resonant circuits which resonate with magnetic field energy of one frequency transmitted from the power transmitting coil.

FIG. 2 illustrates a relationship between the transmitted power and the distance between the power transmitting coil and the power receiving resonant coil. In FIG. 2, the horizontal axis represents the distance between the power transmitting coil 12 and the power receiving resonant coil 21, and the vertical axis represents the normalized transmitted power (%). The transmission frequency is a constant value of the resonant frequency f of the power receiving resonant coil 21, and the power supplied to the power transmitting coil 12 is a constant value. In FIG. 2, a relationship between the coil distance and the transmitted power is illustrated by a dotted line in the case where the power receiving device 20 of FIG. 1 receives power from the power transmitting device 100 of FIG. 5.

As indicated in the waveform W1 of FIG. 2, the transmitted power changes in accordance with a change in the coil distance which is a distance between the power transmitting coil 12 and the power receiving resonant coil 21. Specifically, the transmitted power of the power transmitting apparatus of FIG. 1 is maximized in the case where the coil distance is equal to zero. The transmitted power is more reduced as the coil distance more increases.

As can be seen from the above discussion, the power transmitting device 10 has the power transmitting coil 12 a resonance point of which is different from that of the power receiving resonant coil 21 and which transmits power supplied from the power supply unit 11 as magnetic field energy to the power receiving resonant coil 21 which resonates at the resonant frequency causing the magnetic field resonance. Through the process, the power receiving device 20 more improves transmitted power as the coil distance between the power transmitting coil 12 and the power receiving resonant coil 21 is shorter.

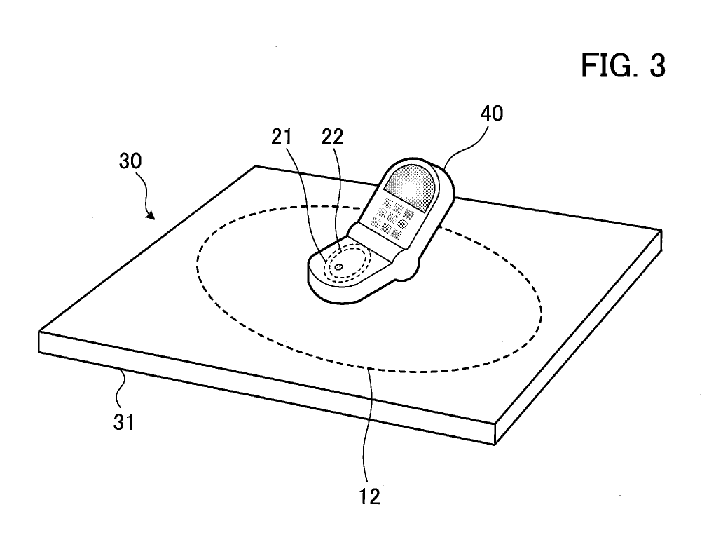

FIG. 3 illustrates an application example of the power transmitting apparatus. In FIG. 3, a battery charger 30 and an electronic device 40 are illustrated. Examples of the electronic device 40 include a cellular phone and a notebook computer.

The battery charger 30 has a charging cradle device 31 which mounts the electronic device 40. The charging cradle device 31 has the power transmitting device 10 illustrated in FIG. 1. In the charging cradle device 31 of FIG. 3, only the power transmitting coil 12 of FIG. 1 is illustrated, and the charging cradle device 31 further has the power supply unit 11.

The electronic device 40 has the power receiving device 20 illustrated in FIG. 1. In the electronic device 40 of FIG. 3, only the power receiving resonant coil 21 and power pickup coil 22 of FIG. 1 are illustrated, and the electronic device 40 further has the load 23. Hereinafter, the description will be made assuming that the load 23 of the electronic device 40 is a battery.

In order to charge a battery of the electronic device 40, the electronic device 40 is mounted on the charging cradle device 31 of the battery charger 30. As a result, a distance between the power transmitting coil 12 of the battery charger 30 and the power receiving resonant coil 21 of the electronic device 40 is, for example, equal to several millimeters and becomes short, and the transmitted power becomes large as illustrated in FIG. 2. Accordingly, the battery of the electronic device 40 may be charged by the sufficient transmitted power.

The resonant frequency of the power receiving resonant coil 21 of the electronic device 40 is further set to be the same as that of the power transmitting resonant coil 103 of FIG. 5. Through the process, the electronic device 40 receives power also from the battery charger having the power transmitting device 100 of FIG. 5 as described below.

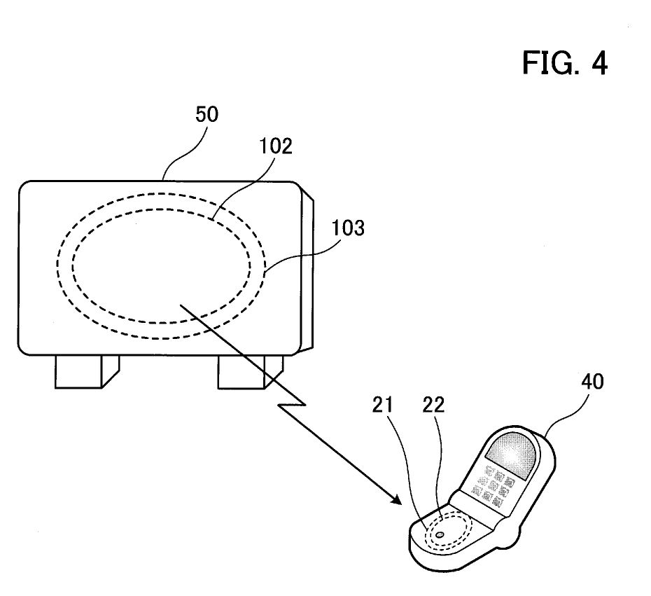

FIG. 4 illustrates another application example of the power transmitting apparatus. In FIG. 4, the battery charger 50 and the electronic device 40 are illustrated. The electronic device 40 is illustrated in the same manner as in FIG. 3, and the detailed description will not be repeated.

The battery charger 50 has the power transmitting device 100 illustrated in FIG. 5. In the battery charger 50 of FIG. 4, only the power supply coil 102 and power transmitting resonant coil 103 of FIG. 5 are illustrated, and the battery charger 50 has also the power supply unit 101.

As described above, the resonant frequency of the power receiving resonant coil 21 of the electronic device 40 is further set to be the same as that of the power transmitting resonant coil 103 of the battery charger 50. Accordingly, the transmitted power is maximized at the time of the optimal distance d0 as illustrated in FIG. 9. In other words, the power transmitting apparatus of FIG. 4 transmits power, for example, at a distance of several hundred millimeters.

As can be seen from the above description, the battery chargers 30 and 50 each have the power transmitting coil 12 a resonance point of which is different from that of the power receiving resonant coil 21 and transmit power supplied from the power supply unit as magnetic field energy to the power receiving resonant coil 21 of the electronic device 40 which resonates at the resonant frequency causing the magnetic field resonance. Through the process, without modifying or changing the power receiving device 20 capable of receiving power through the magnetic field resonance, for example, the electronic device 40 mounts it on the charging cradle device 31 of the battery charger 30 (at a short distance) and charges a battery as illustrated in FIG. 3. For example, the electronic device 40 further charges a battery at a distance from the battery charger 50 (at a long distance) as illustrated in FIG. 4.

In order to correspond to the battery charger of FIG. 3, the electronic device 40 capable of receiving power through the magnetic field resonance further eliminates the need to modify or change the power receiving device 20. Since eliminating the need to include a circuit according to the power transmitting devices 10 and 100, the electronic device 40 further suppresses cost from rising up. The electronic device 40 further trims weight of the power receiving device 20.

In FIG. 3, it is described that the charging cradle device 31 is horizontal and the electronic device 40 is mounted thereon; however, it is not limited thereto. For example, the charging cradle device 31 may be vertical and the electronic device 40 may be held in contact with the charging cradle device 31. In other words, the power transmitting coil 12 of the power transmitting device 10 may be made as close as possible to the power receiving resonant coil 21 of the power receiving device 20.

The proposed power transmitting device and power transmitting apparatus make transmitted power larger as a distance between a power transmitting coil and a power receiving resonant coil is shorter.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A power transmitting device comprising a power transmitting coil having a resonance point different from that of a power receiving resonant coil which transmits power supplied from a power supply unit as magnetic field energy to the power receiving resonant coil which resonates at a resonant frequency causing magnetic field resonance.

2. The power transmitting device according to claim 1, wherein to the power transmitting coil, the power supply unit is connected and the power is supplied.

3. A power transmitting apparatus comprising:
a power transmitting device including a power transmitting coil having a resonance point different from that of a power receiving resonant coil which transmits power supplied from a power supply unit as magnetic field energy to the power receiving resonant coil which resonates at a resonant frequency causing magnetic field resonance; and
a power receiving device including the power receiving resonant coil which receives the magnetic field energy transmitted from the power transmitting coil at the resonant frequency.

4. The power transmitting apparatus according to claim 3, wherein to the power transmitting coil, the power supply unit is connected and the power is supplied.

5. The power transmitting apparatus according to claim 3, wherein one coil resonates with magnetic field energy transmitted from the power transmitting coil.
